(19) United States
(12) Patent Application Publication
(10) Pub. No.: US 2023/0343311 A1
(43) Pub. Date: Oct. 26, 2023

(54) ONE-SHOULDER STRAP FOR SAXOPHONE

(71) Applicant: Se Sang LEE, Bucheon-si (KR)

(72) Inventor: Se Sang LEE, Bucheon-si (KR)

(21) Appl. No.: 18/024,760

(22) PCT Filed: Feb. 10, 2021
(86) PCT No.: PCT/KR2021/001847

§ 371 Date: Mar. 4, 2023

(30) Foreign Application Priority Data
Sep. 4, 2020 (KR) 10-2020-0112712

(51) Int. Cl. G10G 5/00; G10D 7/08; G10D 9/00

(52) U.S. Cl. CPC G10G 5/005; G10D 7/08; G10D 9/00

(57) ABSTRACT

It has been very difficult for women with long hair to wear existing neck straps for saxophones. To address this, straps for saxophones and wind instruments are configured to be worn on one shoulder rather than the neck, and thus wind-instrument players of all mankind can use them conveniently. In order to wear the strap for a saxophone on one shoulder, materials for supporting the saxophone strap include strong supports (A, B, C, D, E, F). In addition, the supports adjust angles (11, 12, 13, 14, 15) and lengths (1, 2, 3, 4, 5, 6) to be suitable for the body. In addition, at parts where the supports come into contact with the abdomen and back, pedestals (23, 22) hold the supports. Also, a string having a ring (G)for hanging the saxophone is connected to the supports. The above components are firmly coupled to one another to form the one-shoulder strap for a saxophone.

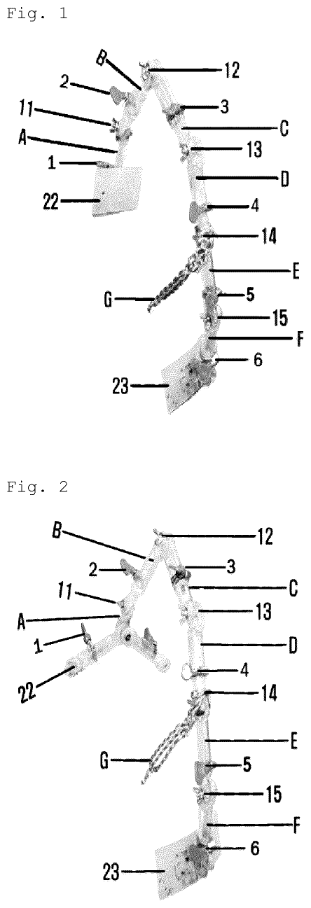

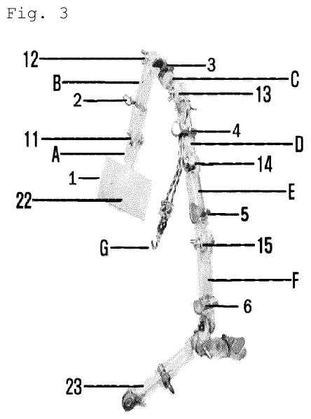

### FIELD OF INVENTION

The present invention relates to a saxophone strap.

Women with long hair have a lot of inconveniences when wearing a saxophone necklace around their necks.

To address such a problem,

the present invention provides a one-shoulder strap for a saxophone to hang a saxophone on one shoulder without hanging it around the neck.

### BACKGROUND OF INVENTION

Existing saxophone straps are generally made to be worn around the neck.

When worn around the neck, women with long hair have a problem with wearing a saxophone strap around the neck, which could be inconvenient and time-consuming.

To address the problems, a one-shoulder strap for a saxophone which can be easily worn on one shoulder without hanging it around the neck has been developed.

### SUMMARY OF INVENTION

### Technical Problem to be Solved

Conventionally, women had a lot of inconvenience due to their long hair when wearing a saxophone necklace around the neck.

Therefore, the present invention has been made in view of the above problems, and it is one object of the present invention to provide a one-shoulder strap for a saxophone to hang a saxophone on one shoulder without hanging it around the neck.

### Technical Solution

In accordance with an aspect of the present invention, the above and other objects can be accomplished by the provision of a saxophone holder to be worn on one shoulder so as to relieve the inconvenience of wearing a saxophone necklace around the neck.

Supports of the saxophone holder are made of hard materials.

In addition, connectors for the supports allow adjusting a length and angle to suit the body.

In addition, a string to hang a saxophone is connected to the solid supports.

parts of the back and abdomen where the supports touch are supported by pedestals.

The one-shoulder strap for a saxophone is manufactured such that it can be hung on one shoulder by firmly tightening elements that constitute the supports and the connectors.

### Effect of Invention

Women with long hair have a lot of inconveniences when wearing a saxophone necklace around their necks.

A one-shoulder strap for a saxophone according to the present invention can be worn on one shoulder instead of hanging it around the neck, so that women with long hair can easily wear it on one shoulder, which is convenient and easy to use.

### BRIEF DESCRIPTION OF DRAWINGS

Reference numerals A, B, C, D, E and F indicate robust supports.

Reference numerals 1, 2, 3, 4, 5 and 6 serve to adjust the lengths of supports.

Reference numerals 11, 12, 13, 14 and 15 serve to adjust the angle of supports.

Reference numeral G indicates a looped string for connecting a saxophone and is connected to supports.

Reference numerals 22 and 23 indicate pedestals of supports.

When the components are tightly tightened and connected while adjusting the length and angle to suit the body, a one-shoulder strap for a saxophone that can be worn on one shoulder is completed.

### BEST MODE FOR CARRYING OUT THE INVENTION

The components of Reference numerals A, B, C, D, E and F serving as supports of a saxophone holder;

the components of Reference numerals 11,12, 13, 14 and 15 serving to adjust the angles of the supports; and

the components of Reference numerals 1, 2, 3, 4, 5 and 6 serving to adjust the lengths of the supports are firmly tightened and connected while adjusting the lengths and angles thereof to suit the body.

In addition, the looped string G of Reference numerals is connected to the supports.

In addition, the components of Reference numerals 22 and 23, which touch the abdomen and the back, support the supports.

A one-shoulder strap for a saxophone is completed by firmly combining the components.

### MODE FOR CARRYING OUT THE INVENTION

A robust one-shoulder strap for a saxophone is completed by adjusting and firmly coupling the angle and length of components constituting the strap to suit the body.

### INDUSTRIAL APPLICABILITY

By using a one-shoulder strap for a saxophone of the present invention, a variety of people who wear a saxophone or wind instrument, for example, women with long hair, men wearing ties, or people wearing earphones, can easily and comfortably wear the instrument on one shoulder. Therefore, the availability of the present invention is very high.

Reference numerals A, B, C, D, E and F indicate robust supports.

Reference numerals 1, 2, 3, 4, 5 and 6 serve to adjust the lengths of supports.

Reference numerals 11, 12, 13, 14 and 15 serve to adjust the angle of supports.

Reference numeral G indicates a looped string for connecting a saxophone and is connected to supports.

Reference numerals 22 and 23 indicate pedestals of supports.

When the components are tightly tightened and connected while adjusting the length and angle to suit the body, a one-shoulder strap for a saxophone that can be worn on one shoulder is completed.

1. The present invention relates to a strap for a saxophone and wind instruments. Conventional saxophone necklaces are very inconvenient for women with long hair to wear around their necks. To solve this inconvenience, the present invention provides a strap for a saxophone and wind instrument which is not hung around the neck, but hung on one shoulder to be easily and comfortably worn by wind instrument players. To hang a saxophone holder on one shoulder, supports for supporting the saxophone holder are made of a hard material, and the supports have an angle and length that fit the body. In addition, a string for hanging a saxophone is connected to the supports. These components are comprised in the one-shoulder strap for a saxophone and wind instruments.

2. The strap according to claim 1, wherein pedestals supporting the back are formed into two prongs to support a saxophone.

3. The strap according to claim 1, wherein ventral pedestals, which support the abdomen to support a saxophone, are formed into two prongs.
